(19) United States
(12) Patent Application Publication
(10) Pub. No.: US 2026/0211544 A1
(43) Pub. Date: Jul. 23, 2026

(54) GUIDANCE FOR GEOMETRICAL AND OPTICAL MAGNIFICATION IN X-RAY MICROSCOPE

(71) Applicant: CARL ZEISS X-RAY MICROSCOPY, INC., Dublin, CA (US)

(72) Inventors: Susan CANDELL, Lafayette, CA (US); Naomi KOTWAL, Livermore, CA (US); Hauyee CHANG, Concord, CA (US); Erich KUHLMAN, San Francisco, CA (US); Stephen KELLY, San Francisco, CA (US); Anke DUTSCHKE, Aalen (DE)

(21) Appl. No.: 19/157,881

(22) PCT Filed: Feb. 27, 2024
(86) PCT No.: PCT/US2024/017447

§ 371 Date: Aug. 19, 2025

Related U.S. Application Data
(60) Provisional application No. 63/487,110, filed on Feb. 27, 2023.

(51) Int. Cl. G06F 3/04845; G01N 23/046; G21K 7/00

(52) U.S. Cl. CPC G06F 3/04845; G01N 23/046; G21K 7/00; G01N 2223/401; G06F 2203/04806

(57) ABSTRACT

A user interface rendered on a display of a microscopy system provides a workflow for acquiring a survey of 2D projection images at two different angles and then uses a region of interest (ROI) tool that can move around the images to locate the center of the rotational axis in all 3 dimensions (X, Y, Z).

### RELATED APPLICATIONS

This application claims the benefit under 35 USC 119(e) of U.S. Provisional Application No. 63/487,110, filed on Feb. 27, 2023, which is incorporated herein by reference in its entirety.

### BACKGROUND OF THE INVENTION

X-ray microscopy (XRM) is a powerful imaging technique for analyzing internal structures on the micro to nano scale. XRM systems provide high resolution images of samples, allowing for detailed study of their properties. XRM systems use a beam of x-rays to illuminate the samples, which is then imaged using a detector. The x-rays are then analyzed to produce an image or projection of the sample.

X-ray computed tomography (CT) is a non-destructive technique for inspecting and analyzing internal structures of samples. Tomographic volume data sets are reconstructed from a series of these projections via standard CT reconstruction algorithms, as the samples are scanned at different angles.

There are a number of different configurations for x-ray CT systems. In x-ray microscopy systems, because the x-ray sources and detectors are large and the samples or objects being scanned are typically small, the x-ray sources and detectors are largely fixed, while the samples are rotated in the x-ray beam, in contrast to medical CT systems in which the patient is stationary and the sources and detector rotate around the patient.

X-ray microscopy systems are often arranged in a relatively simple projection geometry, in which the x-rays penetrate the sample, and the transmitted x-rays are collected by the detector. With this setup, the geometrical magnification of the system is:

$$M = \frac{{L}_{s} + {L}_{d}}{{L}_{s}} , \qquad ( 1 )$$

where, Lₛ is the source to sample distance and the L_{d} is the sample to detector distance.

To achieve high resolution, some x-ray microscopy systems further provide for optical magnification such as with a combination of a camera, scintillator, and microscope objective to provide additional optical magnification in a range between 2× and 100×, or more. The scintillator converts the x-rays into an optical image that is magnified by the microscope objective and then detected by the camera.

### SUMMARY OF THE INVENTION

A challenge in x-ray microscopy is to locate the center of the rotational axis for the desired tomography based only on 2D projections of the sample at that location. This challenge is exacerbated for X-ray microcopy systems that support both x-ray and optical magnifications. The desired location within the sample and size of the final tomographic volume can be achieved in many ways, so finding the ‘best’ system setup can be an iterative and lengthy process performed by the user. Often the system has to first be configured at the ‘best’ system setup. Then a projection image is taken at that desired location in order to save it in the recipe for the tomography. This process is called ‘Scout’ as the user is scouting the possible image space to get the best tomography for their needs.

The present invention concerns the ability to define a region of interest and center of rotation in a sample by acquiring a survey of 2D projection images at two, for example, different angles and use a region of interest (ROI) tool that can move around the images to locate the center of the rotational axis in all 3 dimensions (X, Y, Z). In the current example, this definition is performed in a computer user interface and associated workflow in a process called projection scout.

In particular, a projection scout survey scan is performed. This scan includes at least two projections of the sample at different angles of the sample, and these projections are used to define the location and size of a tomography within that survey image without having to physically reconfigure the system to change the tomography system setup. The survey scans are typically a full field of view horizontally of the sample, and the subsequent tomography(s) are placed in the survey scan using a movable ROI tool. By moving the ROI in both images, the unique X, Y, Z location of the center of the tomography is specified. The ROI tool can also be sized to reflect the pixel size of the tomography desired and will change for different camera binning. This ROI location and size are then used to determine the best optical magnification to use, and the best geometrical magnification based on the size of the sample from a collision model. The user can then save this to the recipe for the tomography without having to physically change the system setup in a process call projection scout.

This invention also concerns the ability define a recipe by acquiring a quick tomography of the sample and uses a ROI tool in the 3D volume planes to locate the center of the rotational axis of the tomography. The ROI tool can also be sized to reflect the pixel size desired in the tomography. This ROI location and size are then used to determine the best optical magnification to use, and the best geometrical magnification based on the size of the sample from a collision model. The user can then save this to the recipe for the tomography without having to physically change the system setup in a process call volume scout.

Preferably, in the volume scout, a tomographic reconstruction is employed. This is preferably a fast tomography that can be acquired and reconstructed then viewed in a 3D Viewer. Using ROI tools in the three (3) orthogonal views, the user can move the ROI to any location within the field of view, and the X, Y, Z location of the center of the tomography is thereby specified. The ROI tool can also be sized to reflect the pixel size of the tomography desired and will change for different binning.

In both the projection scout survey scan and the volume scout tomographic reconstruction, multiple ROIs can be created and moved and sized for multiple tomographies. Once the placement and size of an ROI is completed, the optical magnification can be determined, and the geometric magnification can also be determined based on the size of the sample from the sample collision envelope. If multiple optical magnifications can be used to achieve the desired pixel size, the user is presented with options and allowed to select. The ‘recommended’ optical magnification is preferably determined based on system performance knowledge.

In general, according to one aspect, the invention features a user interface rendered on a display of an X-ray microscopy system including a computer that processes projection data from the X-ray-microscopy system. The user interface displaying 2D projection images of a sample taken at two different rotational angles that are defined with respect to a rotational axis that is perpendicular or declined to an X-ray beam generated by an X-ray source subsystem and detected by a detector subsystem. The user interface also displays a region of interest (ROI) tool that is moved by user using user interface devices around the images to select a ROI and/or locate a center of the rotational axis of a sample table of the X-ray microscopy system.

Preferably, the location and size of a tomography of the sample can be defined without having to physically reconfigure the X-ray microscopy system to change the tomography system setup. Moving the ROI by user using the user interface devices in the 2D projection images specifies the unique X, Y, Z location of the center of the tomography.

The selected ROI location and size are preferably used to determine a best geometrical magnification based on the size of the sample from a collision model. The placement and size of the ROI can be used to determine optical magnification and geometric magnification. In particular, the center of the rotational axis is located in all 3 dimensions (X, Y, Z).

Also, by moving the ROI in both images, the unique X, Y, Z location of the center of the tomography is specified. Also, sizing the ROI is used to reflect a desired pixel size of the tomography. In addition, placement and size of the ROI is used to determine optical magnification and geometric magnification by the by the computer system. The ROI is then applied by the computer subsystem to the precision 3-axis stage that translates and positions the sample along the x, y, and z axes so that sample is positioned to the locked ROL

In general, according to another aspect, the invention features a user interface rendered on a display of an X-ray microscopy system including a computer that processes projection data of a sample from the microscopy system to reconstruct a tomography. The user interface enables the acquisition of projections a sample in a volume scout mode and enables creating, moving and sizing of multiple regions of interest for multiple tomographies with a ROI tool. In a volume scout mode, the user interface displays the tomography along with the ROI tool in 3D volume planes to locate the center of a rotational axis of the tomography. The rotational axis is perpendicular or declined to a beam that is generated by an X-ray source subsystem and detected by a detector subsystem.

The user interface further displays 2D projection images of a sample taken at two different rotational angles in a projection scout mode and displays a region of interest (ROI) tool that is moved by user using user interface devices around the images to select a ROI and/or locate a center of the rotational axis of a sample table of the X-ray microscopy system in the projection scout mode.

Preferably, the ROI tool is sizable to reflect a desired pixel size in the tomography. The selected ROI location and size can determine an optical magnification.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a schematic diagram of an x-ray microscopy system to which the present invention is applied in one embodiment; and

FIGS. 2 through 21 show a user interface generated by the x-ray microscopy system for display on its display device.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element of intervening elements may be present.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

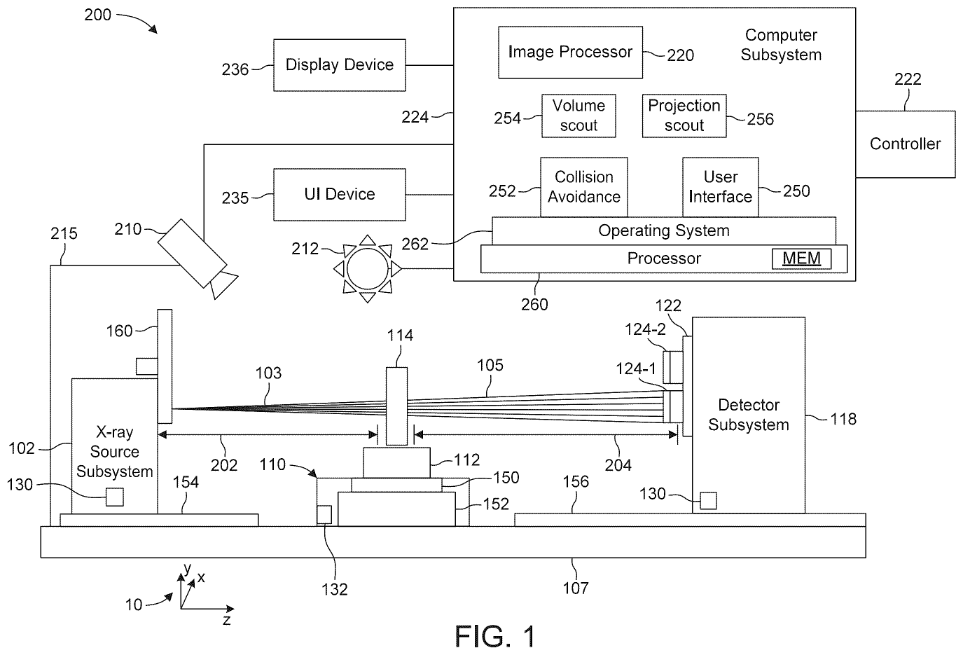

FIG. 1 is a schematic diagram of an XRM system 200 to which the present invention is applicable.

The illustrated microscopy system 200 is an X-ray CT system and generally includes several subsystems. An X-ray source subsystem 102 generates a polychromatic or possibly monochromatic X-ray beam 103. An object stage subsystem 110 with object holder 112 holds a sample or object 114 in the beam and positions and repositions it to enable scanning of the sample 114 in the stationary beam 103, 105. A detector subsystem 118 detects the beam 105 after it has been modulated by the sample. A base, such as a platform or optics table 107, provides a stable foundation for the microscopy system 200 and its subsystems.

In general, the object stage subsystem 110 has the ability to position and rotate the sample 114 in the beam 103. In particular, an object holder or sample table 112 rotates around its axis of rotation R, which is perpendicular or declined to the y-axis. Thus, the object stage subsystem 110 will typically include linear and rotation stages. The illustrated example has a precision 3-axis stage 150 that translates and positions the sample along the x, y, and z axes, very precisely but only over relatively small ranges of travel. This allows a region of interest ROI of the object 114 to be located within the beam 103/105. The 3-axis stage 150 is mounted on a theta stage 152 that rotates the 3-axis stage 150 around its axis of rotation R and thus sample 114 in the beam. The theta stage 152 is in turn mounted on the base 107.

Thus, the frame of reference or coordinate system of the 3-axis stage 150 is related to the frame of reference or coordinate system 10 of the microscopy system 200 by the angular position of the theta stage 152.

The source subsystem 102 will typically be either a synchrotron x-ray radiation source or alternatively a “laboratory x-ray source” in some embodiments.

As used herein, a “laboratory x-ray source” is any suitable source of x-rays that is not a synchrotron x-ray radiation source. Laboratory x-ray source 102 can be an X-ray tube, in which electrons are accelerated in a vacuum by an electric field and shot into a target piece of metal, with x-rays being emitted as the electrons decelerate in the metal. Typically, such sources produce a continuous spectrum of background x-rays combined with sharp peaks in intensity at certain energies that derive from the characteristic lines of the selected target, depending on the type of metal target used.

In one example, source subsystem 102 is a rotating anode (reflective target) type or microfocused source, with a Tungsten target. Targets that include Molybdenum, Gold, Platinum, Silver or Copper also can be employed. Preferably a transmission-type target configuration is used in which the electron beam strikes the thin target from its backside. The x-rays emitted from the other side of the target are used as the beam 103.

The x-ray beam generated by source subsystem 102 is often conditioned to suppress unwanted energies or wavelengths of radiation. For example, undesired wavelengths present in the beam are eliminated or attenuated, using, for instance, energy filters (designed to select a desired x-ray energy range (bandwidth)) held in a filter wheel 160. These energy filters typically include an ‘air’ filter corresponding to no filter along with a set of low energy filters for filtering lower energy x-rays and high energy filters for filtering higher energy x-rays.

When the object 114 is exposed to the X-ray beam 103, the X-ray photons or particles, which propagate through the sample 114, form a modulated beam 105 that is received by the detector subsystem 118. Optionally, an optical magnification stage (containing at least one objective lens) is used to form an image onto the detector subsystem 118 of the microscopy system 200.

Typically, a geometrical and/or optical magnified projection image of the object 114 is formed on the detector subsystem 118. The geometrical magnification of the x-ray stage is equal to the inverse ratio of the source-to-object distance 202 and the source-to-detector distance 204.

To achieve high resolution, an embodiment of the x-ray CT system 200 further utilizes several optical objectives offering different optical magnifications. In one example, the detection system includes a very high resolution detector 124-1. In one example, this high-resolution detector 124-1 has camera, a scintillator, and a microscope objective to provide additional optical magnification in a range between 0.4× and 100×, or more. The scintillator converts the x-rays into an optical image that is then magnified by the microscope objective and then detected by the camera.

Other detectors are often included as part of the detector subsystem 118. For example, the detector subsystem 118 can include a lower resolution detector 124-2. This could be a scintillator and flat panel detector or a camera with a lower magnification microscope objective, in examples. Configurations of one, two, or even more detectors 124 of the detector subsystem 118 are possible.

Preferably, the two or more detectors 124-1, 124-2 are mounted on a turret 122 of the detector subsystem 118, so that they can be alternately rotated into the path of the modulated beam 105 from the sample 114.

Typically, the source subsystem 102 and the detector subsystem 118 are mounted on respective z-axis stages. For example, in the illustrated example, the source subsystem 102 is mounted to the base 107 via a source stage 154, and the detector subsystem 118 is mounted to the base 107 via a detector stage 156. In practice, the source stage 154 and the detector stage 156 are lower precision, high travel-range stages that allow the source subsystem 102 and the detector subsystem 118 to be moved into position, often very close to the object during scanning and then be retracted to allow the object to be removed from, a new object to be loaded onto, and/or the object to be repositioned on the object holder 112 of the object stage subsystem 110.

The present microscopy system 200 has an optical camera 210 such as a video camera that collects image data of the sample 114 held in the object holder or sample table 112. This camera is typically mounted directly or indirectly to the system base 107 via a mounting system 215, such as a bracket. Typically, optical camera 210 collects the images in the visible portion of the spectrum and/or in the adjacent spectral regions such as the infrared. Usually, the optical camera 210 has a CCD or CMOS image sensor. Also included is a light source 212 that illuminates the object in the spectral regions employed by the optical camera.

The operation of the microscopy system 200 and the scanning of the object 114 is controlled by a computer subsystem 224 that often includes an image processor 220 and a controller 222.

The computer system 224 includes one or more processors 260 along with their data storage resources such as disc or solid-state drives, and memory MEM. The processors 260 execute an operating system 262 and various applications run on that operating system 262 to allow for user control and operation of the microscopy system 200. Particularly, a user interface application 250 executes on the operating system 262 and generates a user interface that is rendered on a display device 236 connected to the computer subsystem 224. The user interface enables the operator to control the system and view projection images and tomographic reconstructions. User input device(s) 235 such as a touch screen, computer mouse, and/or keyboard enable interaction between the operator and the computer subsystem 224. A collision avoidance app 252 allows the user to define the physical extent of the sample 114 and then monitors the movement of the x-ray source subsystem 102, the object stage subsystem 110, and the detector subsystem to ensure that the subsystems do not collide with the sample 114.

The controller 222 allows the computer subsystem 224 to control and manage components in the X-ray CT microscope 200 under software control. The controller might be a separate computer system adapted to handle realtime operations or an application program executing on the processor 260. The source subsystem 102 includes a control interface 130 allowing for its control and monitoring by the controller 222. Similarly, the object stage subsystem 110 and the detector subsystem 118 have respective control interfaces 132, 134 for allowing for their control and monitoring by the computer subsystem 224 via the controller 222.

To configure the microscopy system 200 to scan the sample and to adjust other parameters such as the geometrical magnification, the operator utilizes the user interface rendered on the display device 236 and generated by the user interface application 250 to first define the sample using the collision avoidance app 252. Then, the user can safely adjust the source-to-object distance 202 and the source-to-detector distance 204 by respective operation of the source stage 154 and detector stage 156 to achieve the desired scanning setup.

Specifically, the source stage 154 and detector stage 156 include respective motor encoder systems or other actuator systems that allow the computer system 224 via the controller 222 to position the respective x-ray source subsystem 102 and the detector subsystem 118 to specified positions via the control interfaces 130, 134. Further, the source stage 154 and detector stage 156 signal the controller 222 of their actual positions.

The operator of the system under automatic control operates the object stage subsystem 110 to perform the CT scan via computer subsystem, the controller 222 and the control interfaces 130, 132, 134. Typically, the object stage subsystem 110 will position the object by rotating the object about an axis that is orthogonal to the optical axis of the x-ray beam 103, 105 by controlling the theta stage 152 and/or position the sample in the x, y, z axes directions using stage 150.

Using the user interface rendered on the display device 236 by the user interface app 250, the operator defines/selects scanning set up including the scanning setup and acquisition parameters via the UI devices 235. These acquisition parameters include x-ray source voltage settings that help to determine the X-ray energy spectrum and exposure time and number of frames on the X-ray source subsystem 102. The operator also typically selects other settings such as the field of view of the X-ray beam 103 incident upon the sample 114, the number of X-ray projection images to create for the sample 114, and the detector 124-1, 124-2 selected. Generally, the acquisition parameters include X-ray source voltage, X-ray source filtration, camera exposure time, number of frames, and overall number of projections and the scanning setup includes the angles to rotate the sample by the stage subsystem 110. In addition, the source-to-object distance 202 and the source-to-detector distance 204 are often specified and these are converted to the necessary positions or settings for the source stage 154 and detector stage 156 as part of the scanning setup.

In addition, the user interface 250 implements two workflows for assisting the user in scanning setup for tomographic acquisitions. Volume scout 254 guides the user in the acquisition of a tomography of sample and then displays the tomography along with a ROI tool in 3D volume planes to locate the center of the rotational axis of the tomography. Projection scout 256 provides for a workflow including displaying 2D projection images at two different angles and displaying a region of interest (ROI) tool that can move around the images to define a ROI and/or locate the center of the rotational axis in all 3 dimensions (X, Y, Z).

### Operation and Workflow

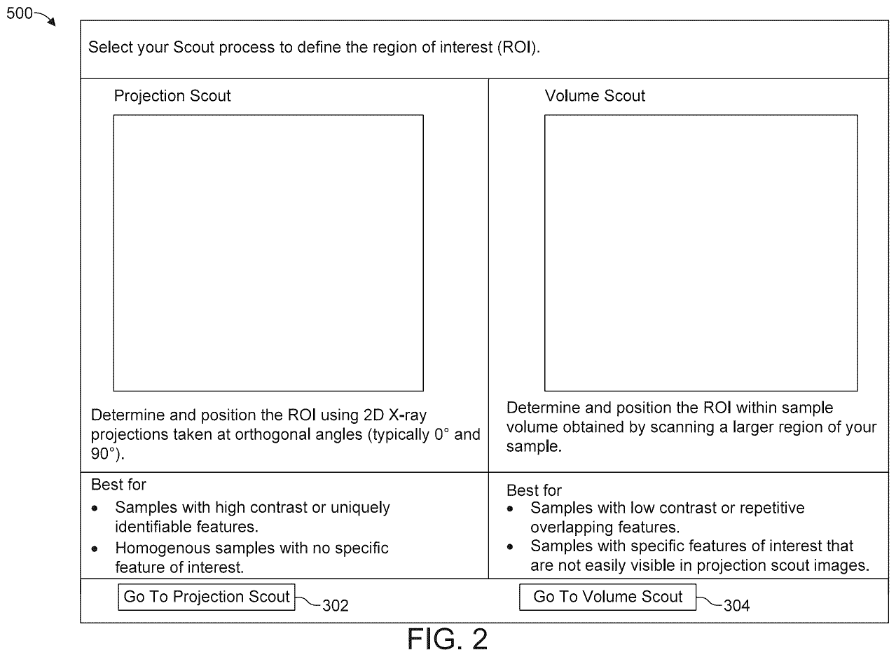

FIG. 2 shows the user interface 500 generated by the user interface app 250 executing on the operating system 262 of the computer system 224 and typically rendered on the display device 236.

Here, the user interface 500 enables the user to select between a projection scout mode by selection of button 302 or a volume scout mode by selection of button 304.

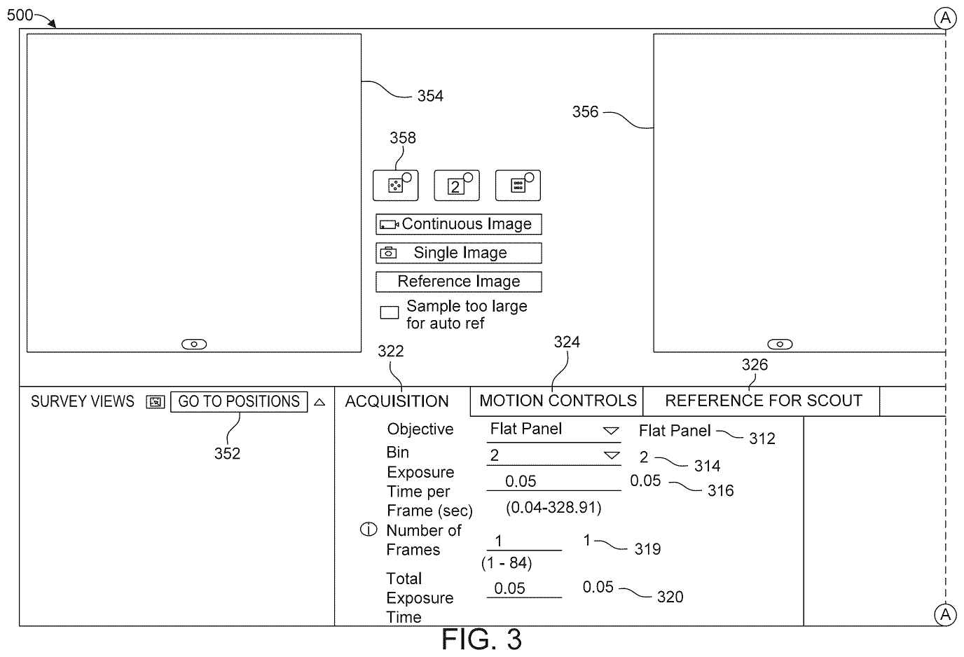

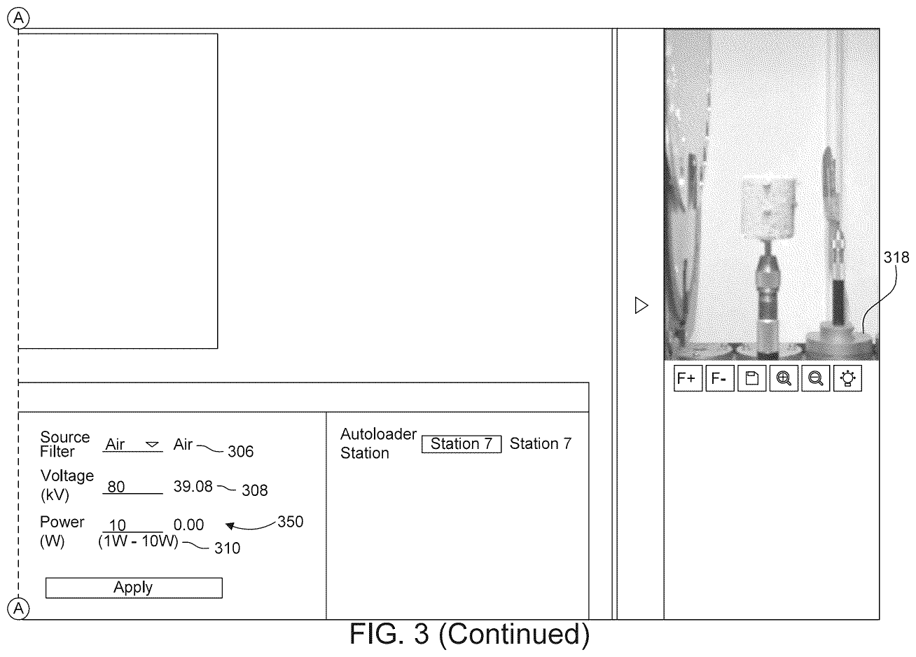

FIG. 3 shows the user interface 500 in response to user selection of the projection scout mode implemented by the projection scout app 256 of the user interface 250.

Acquisition settings are displayed in an acquisition setup region 350 acquisition tab 322 of the user interface 500. There the user can specify the source filter 306, source voltage 308, source power 310, detector (flat panel is shown as selected) 312, binning 314, exposure per frame 316, number of frames 319, and total exposure time 320.

If the user has just generated the sample collision envelope and indicated the height of the sample to scan, the user interface 500 displays the settings necessary to create a full field of view (FOV) survey view.

If a sample collision is present, the option to ‘Go To Positions’ UI button 352 can be selected that will change the system setup to the survey view settings automatically.

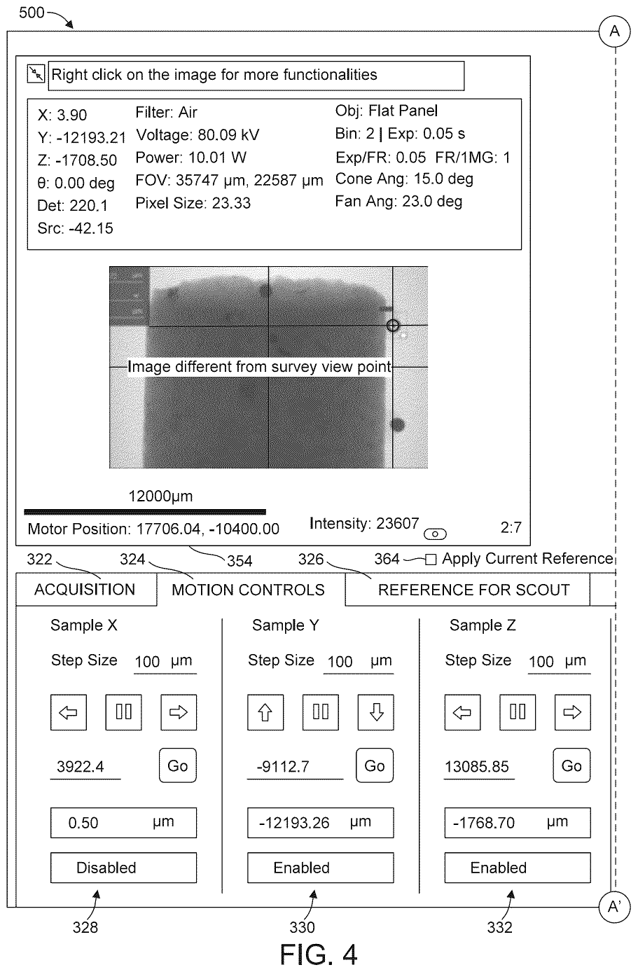

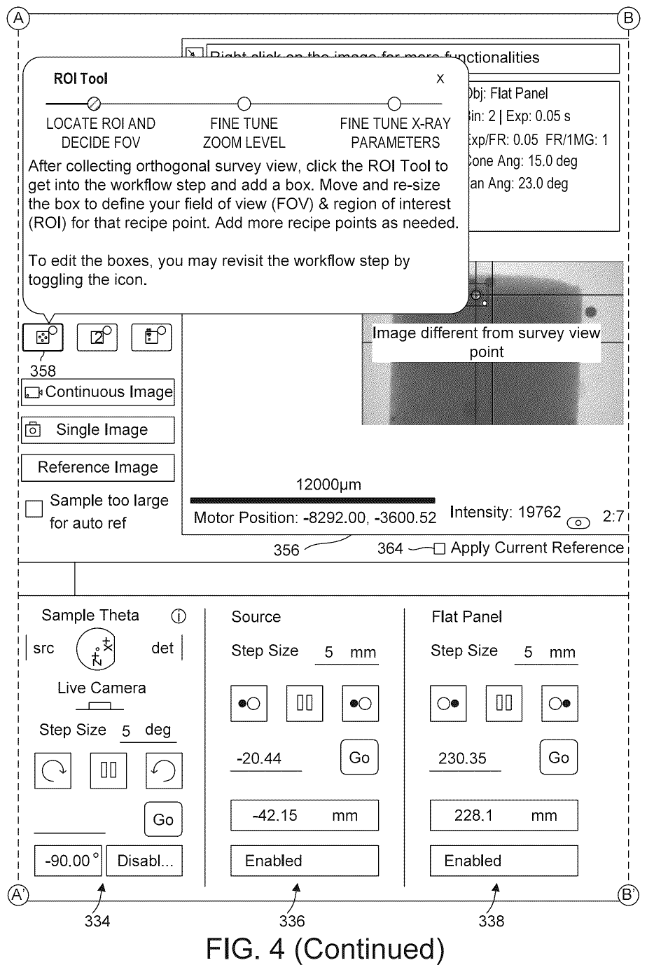

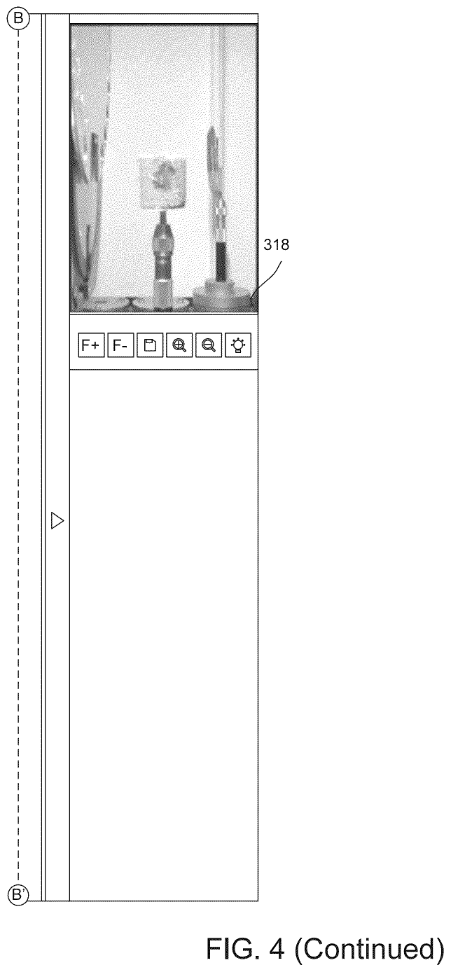

As shown in FIG. 4, the user can then acquire the first survey view in viewport A 354.

Here the motion control tab 324 has been selected. A sample X position control 328, sample Y position control 330, sample Z position control 332, sample theta control 334, source position control 336, and detector position control 338 are displayed in the tab for setting positions.

The user can switch to viewport B 356, change the theta rotation of the sample and acquire a second survey view.

If the two survey views are sufficiently different in angles, the ROI tool UI button 358 becomes available to select.

In the user interface 500, the ROI tool UI button 358 now active,

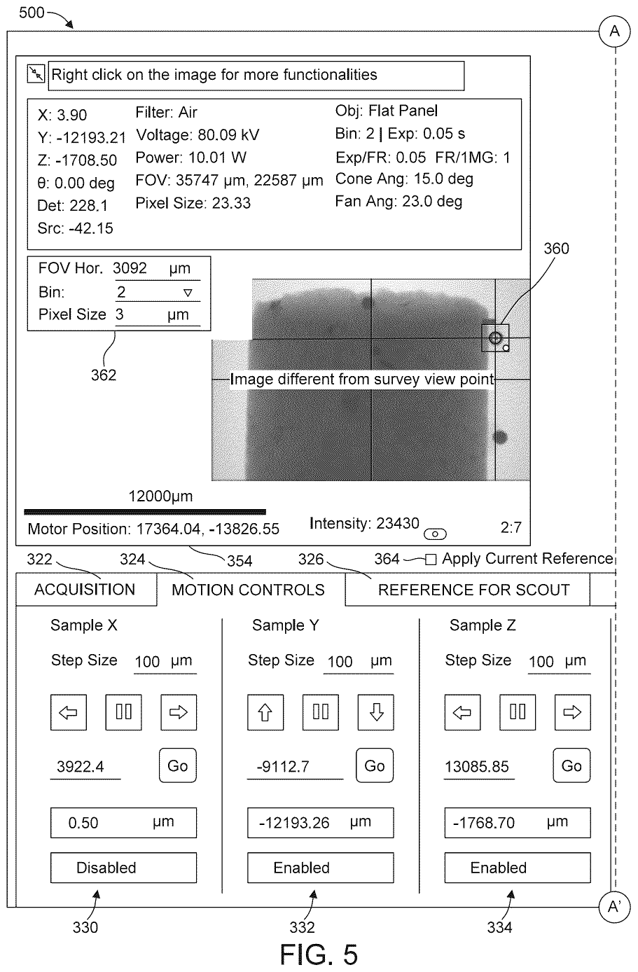

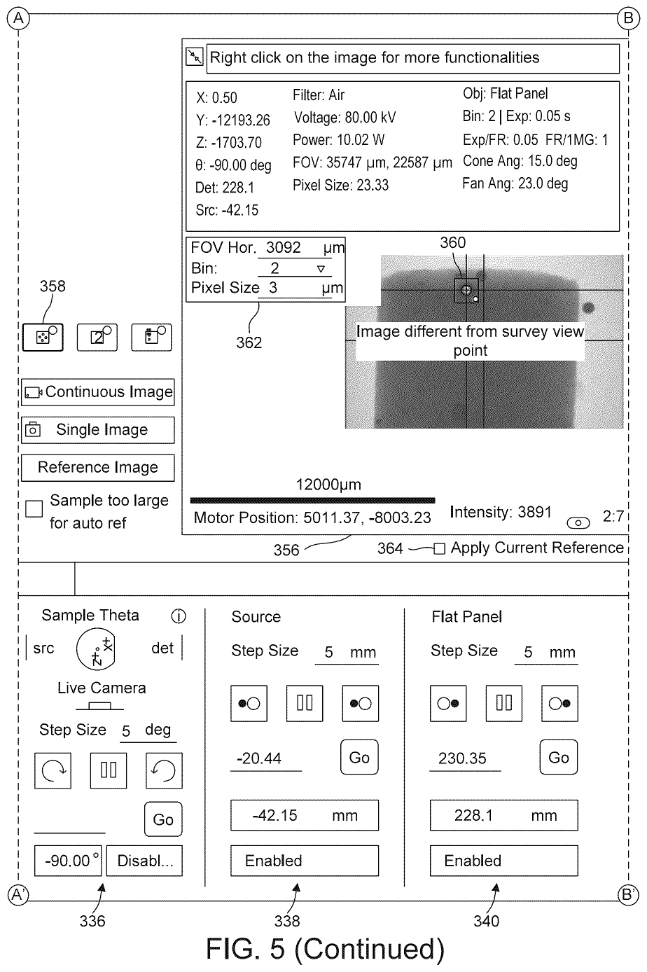

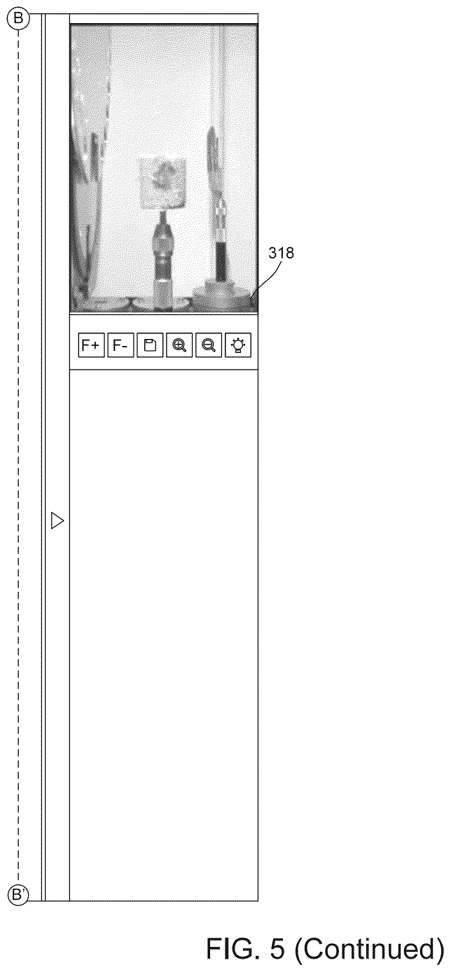

FIG. 5 shows the user interface 500 with the ROI tool 360 displayed in each of viewport A 354 and viewport B 356 upon selection of the ROI tool UI button 358.

For each tomography in the recipe, the ROI tool 360 will appear on the screen at the location and size of the tomography. The ROI tool is moved and sized in either viewport A 354 and/or viewport B 356 by the user manipulating a displayed mouse pointer using the UI device(s) 236. In response, the user interface updates the other view to match the new location.

When the user resizes the ROI tool, the updated pixel size, FOV, and binning displayed inset 362 in each view.

Multiple ROIs can be displayed, representing the different tomographies, and can be color-coded for easier identification.

A tomography can be ‘locked’ so the ROI cannot be moved or sized. The ROI is then applied by the computer subsystem 224 to the precision 3-axis stage 150 that translates and positions the sample along the x, y, and z axes so that sample is positioned to the locked ROI.

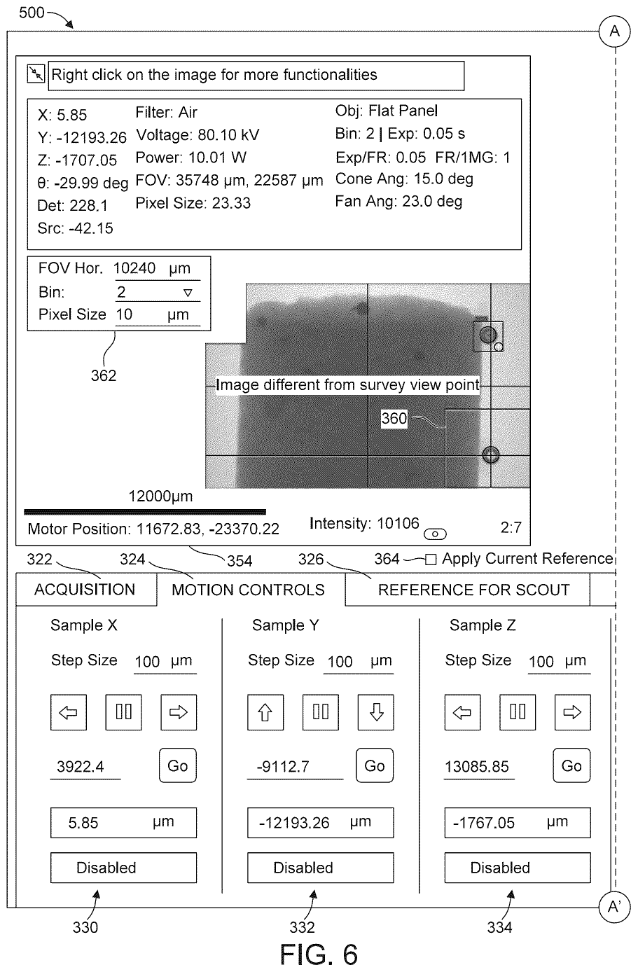

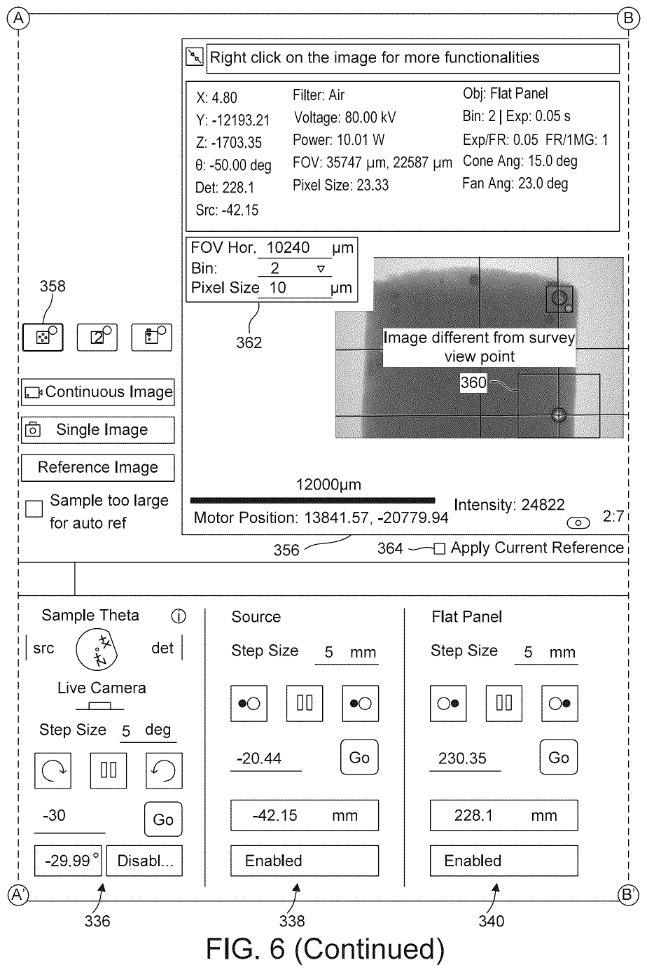

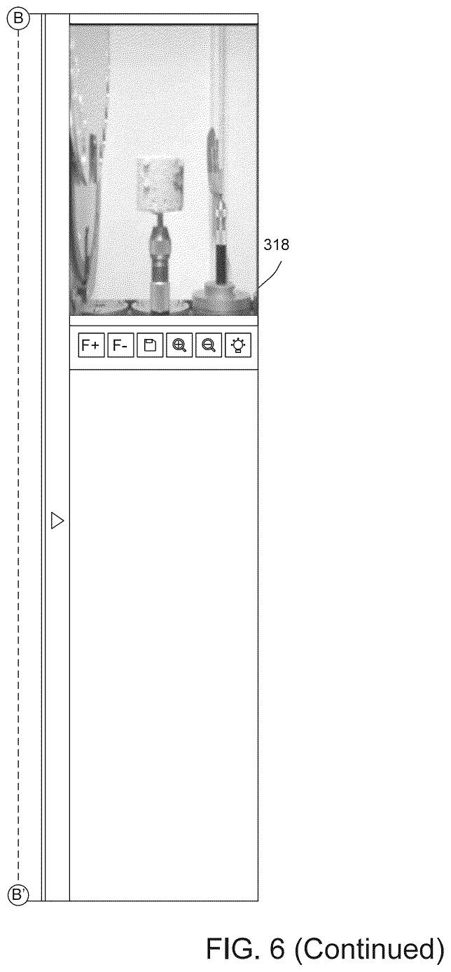

As shown in FIG. 6, if the survey view does not include the position of a tomography from the recipe, an arrow in the user interface 500 indicating the location of that tomography will be displayed to the user.

Also, if a tomography is not within the survey view, the user has the option to move it to the center of the Survey view automatically by selecting box 364 associated with each of viewport A 354 and viewport B 356.

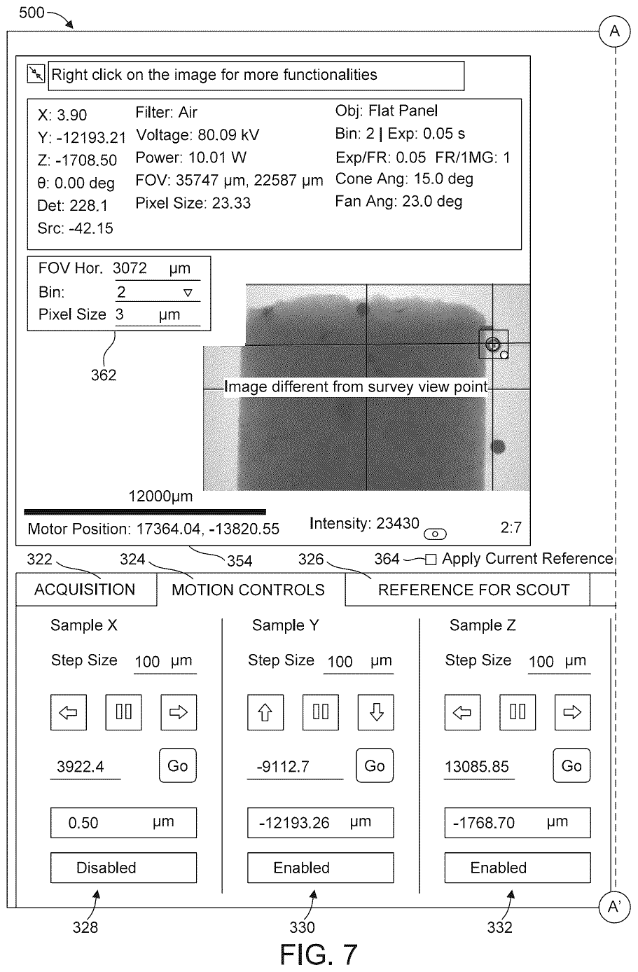

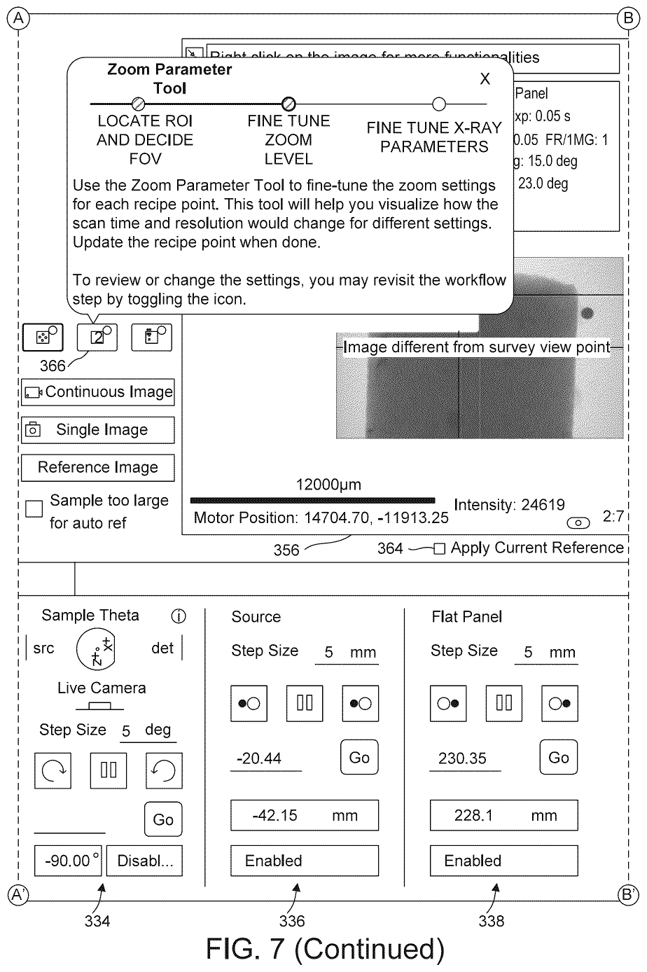

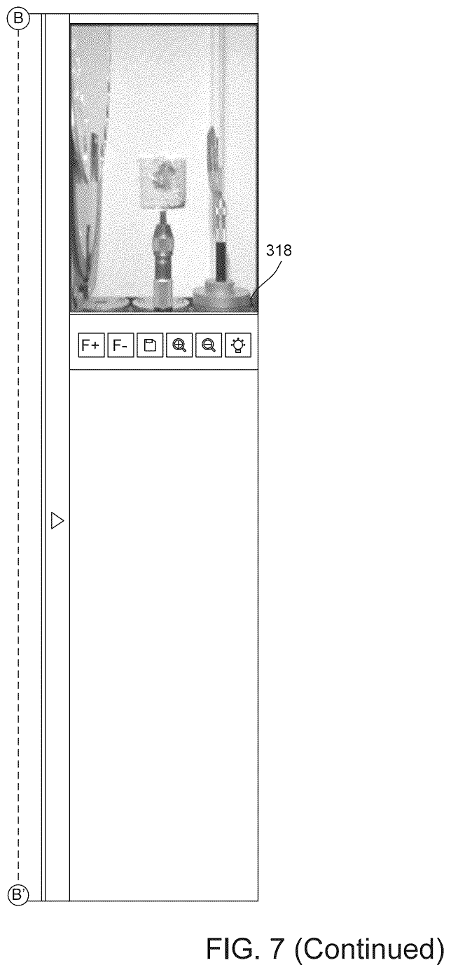

FIG. 7 shows the ROI tool to Zoom Tool.

The ROI location and size can be used to select the optimum objective magnification and determine the safe yet fastest geometric magnification that can be used for that tomography by selecting UI button 366.

When in volume scout mode implemented by the volume scout 254 app of the user interface 250, the user can choose to collect a ‘Quick Tomo’ of the sample in order to determine where to run subsequent tomographies. For some samples, it is just better to visualize the interior in 3D rather than 2D.

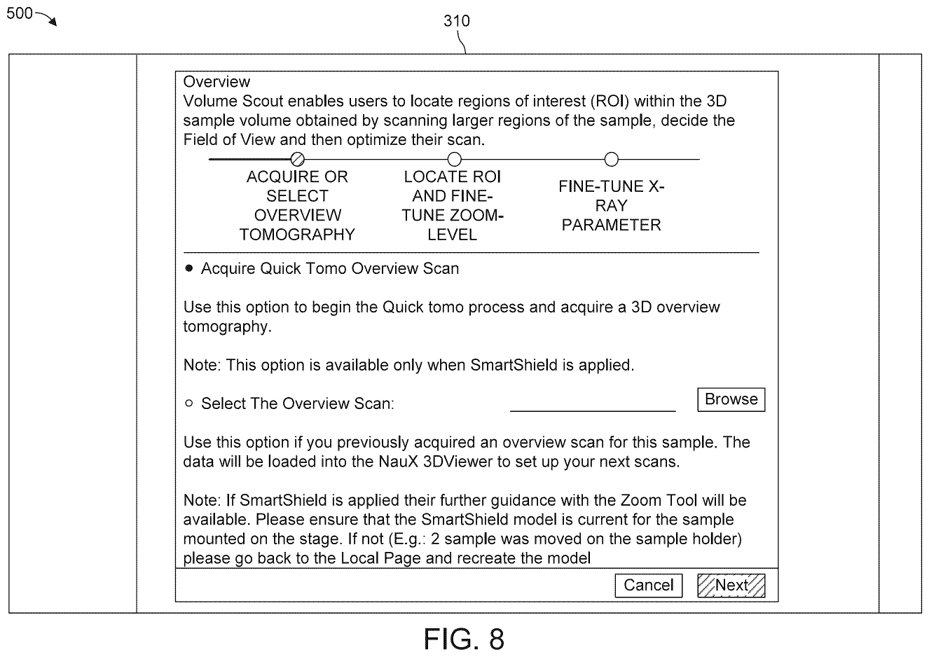

The user can select to acquire a new quick tomography or load a prior tomography to display and locate subsequent tomographies as illustrated in FIG. 8 in transitioning to volume scout.

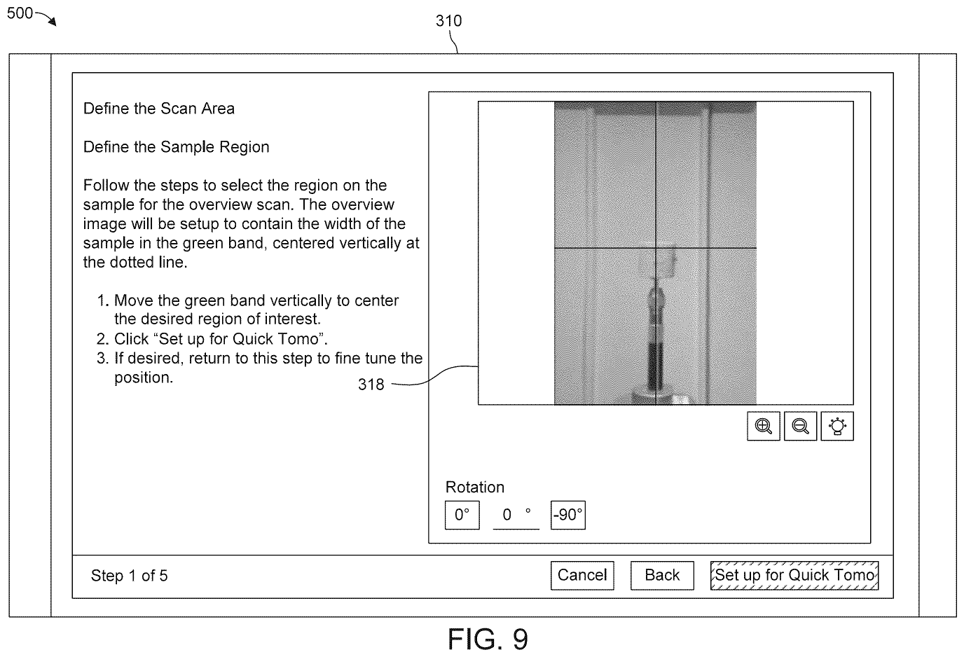

As shown in FIG. 9, the user can use the visual light camera 210 to select where to center the quick tomography. In the illustrated mode, the user interface 500 includes an optical camera pane 318. This displays the current image data received from the optical camera 210.

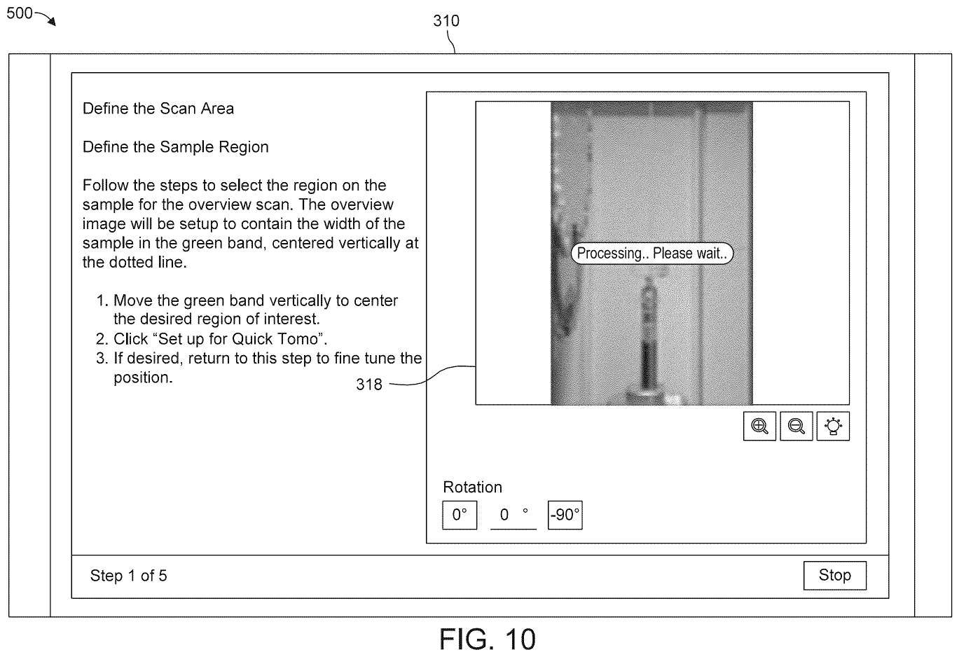

Preferably, the size of the sample has been entered into the system. Thus, the system can move stages and select the best objective or flat panel to use to scan the full sample at the desired location as shown in FIG. 10.

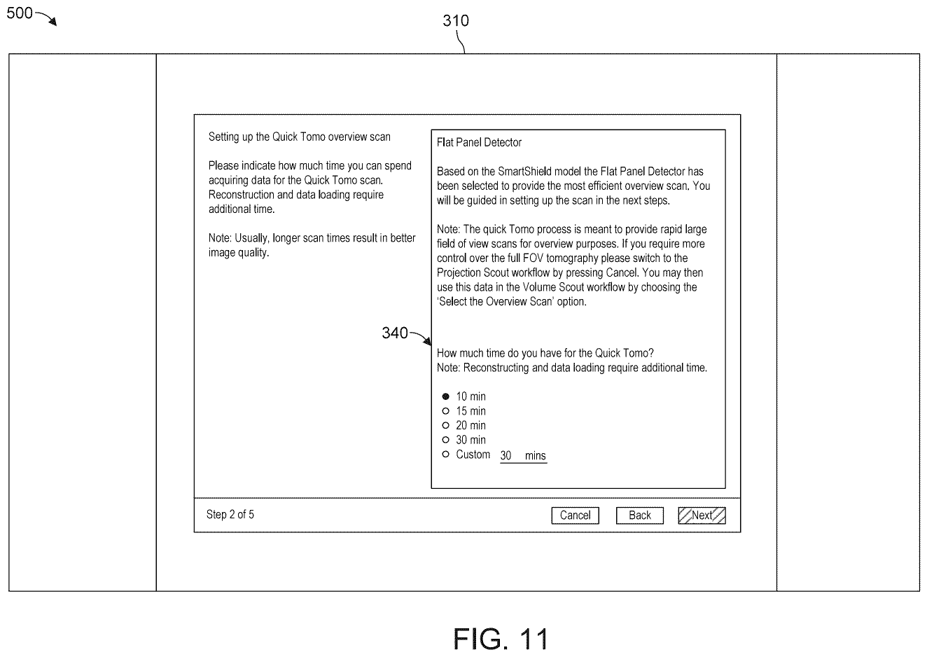

The user interface 500 enables the user to set the time to spend acquiring the quick tomography among a set of radio buttons 340. For smaller, simpler samples, a fast tomography is sufficient, but for bigger or more complicated samples, more time is likely necessary. This is shown in FIG. 11.

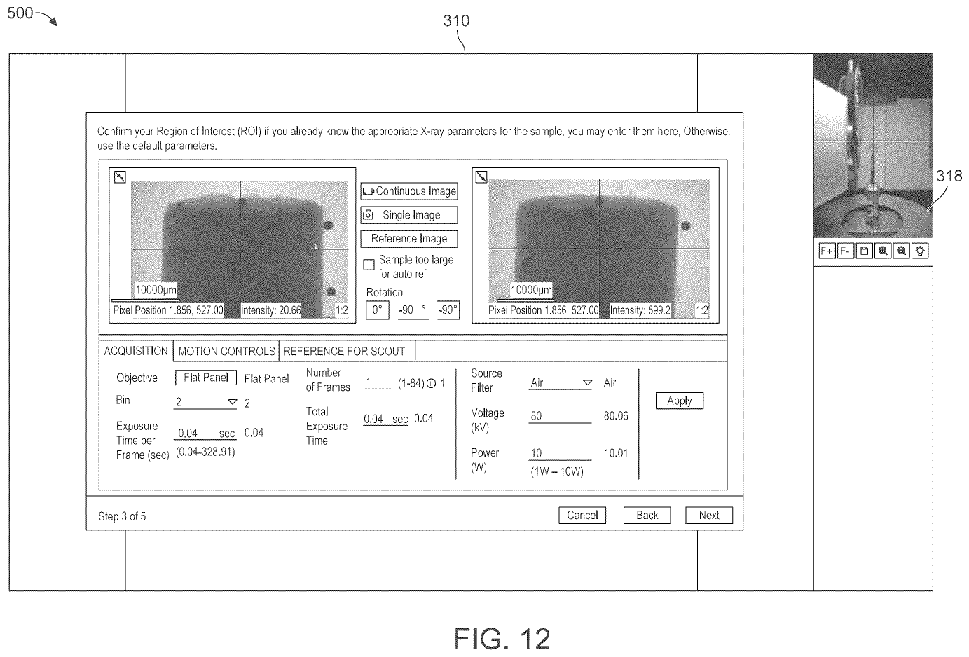

As shown in FIG. 12, after moving the system to the quick tomography positions, the user can confirm that the sample is in the correct location and can modify the positions if necessary.

A reference scan is necessary for all tomographies, including the quick tomography. The sample needs to be moved out of the field of view, and the user has to pick an axis option (direction (+/−) and orientation (X, Y or Z)) one that actually moves the sample far enough to be completely out of the tomography field of view.

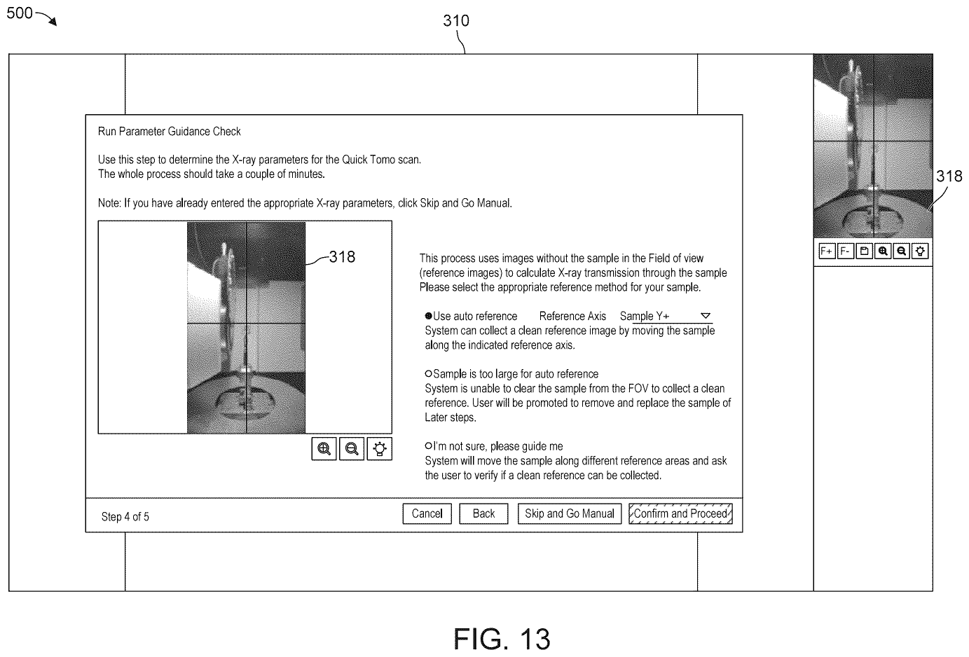

As shown in FIG. 13, the user can select an option if the user is confident that the sample will move far enough. Alternatively, the user can select that the sample is too large to be moved by one of the sample stages, in which case, the system will prompt the user to remove the sample from the sample stage in order to acquire the reference scan. The user can ask for help in determining which direction to move and the system will guide the user by moving through the possible positions and take a reference at each location until the user finds a direction that will be successful.

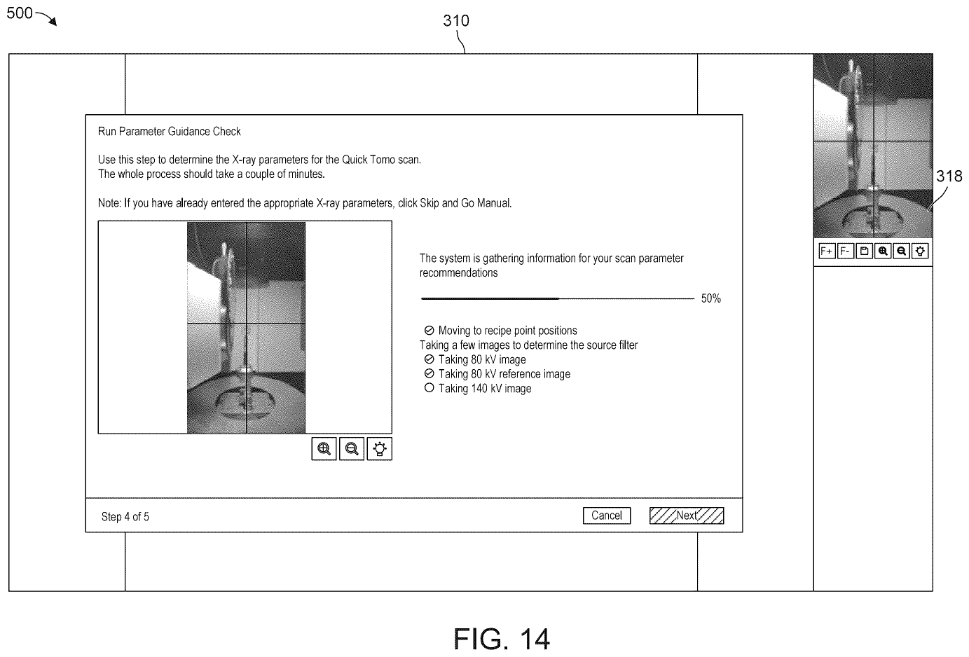

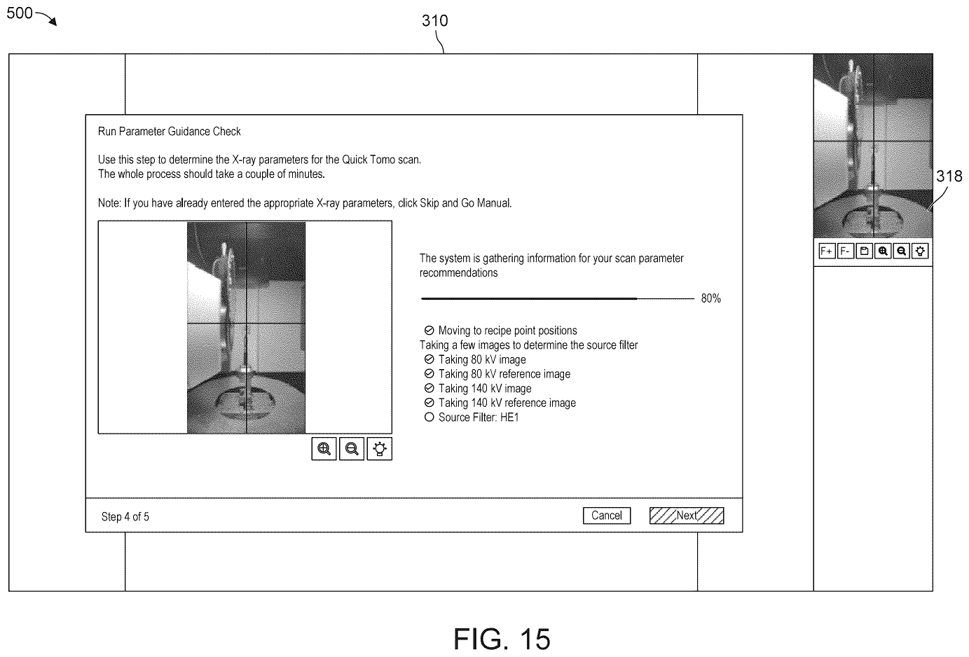

As shown in FIGS. 14 and 15, parameter guidance for the quick tomography automatically takes a series of reference corrected 2D projections of the sample and will select the best x-ray source voltage (kV) and source filter to use for the quick tomography.

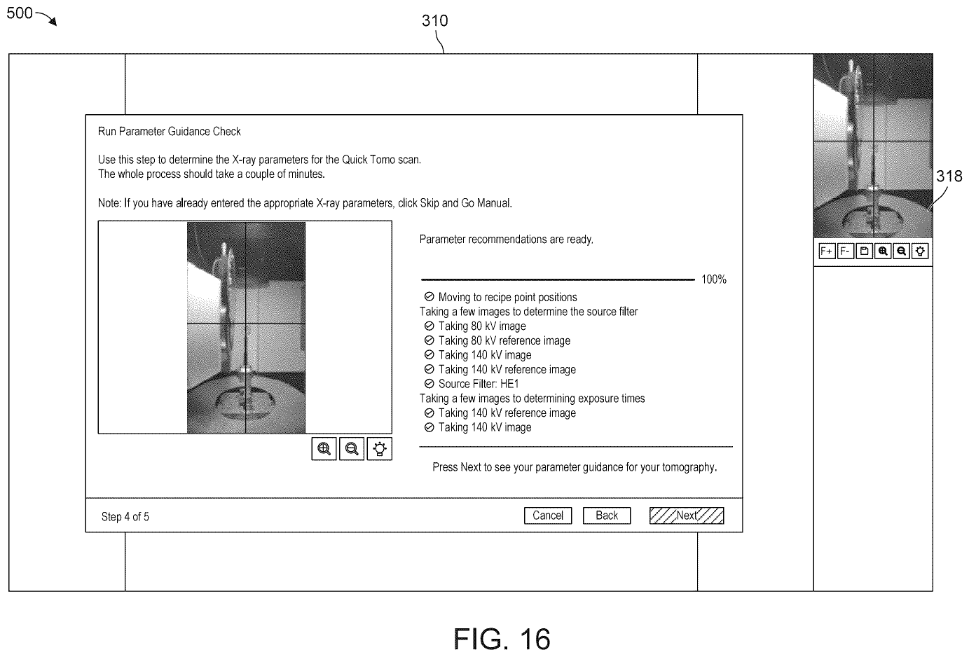

As shown in FIG. 16, the Parameter Guidance will then determine the exposure per frame to use for the quick tomography.

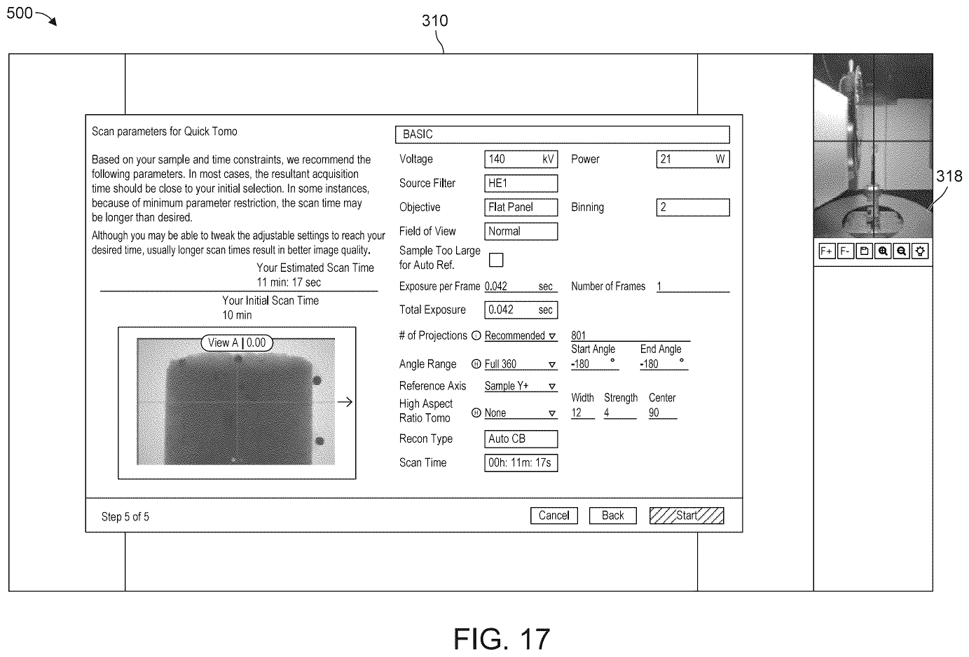

Parameter Guidance will then determine the rest of the quick tomography acquisition parameters based on the exposure per frame and how much total time the user wanted to spend acquiring the quick tomography, as shown in FIG. 17.

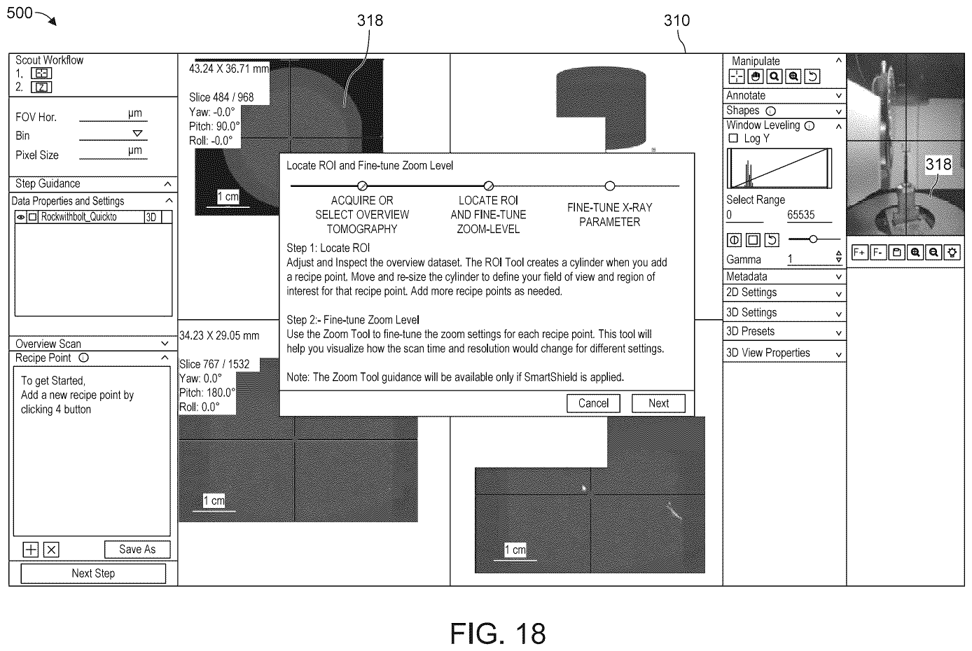

As shown in FIG. 18, the Quick Tomo is acquired and reconstructed and the full tomography loaded into a 3D Viewer where the user can view the volume in all 3 axial planes (XY, XZ, and YZ) plus a 3D render of the volume.

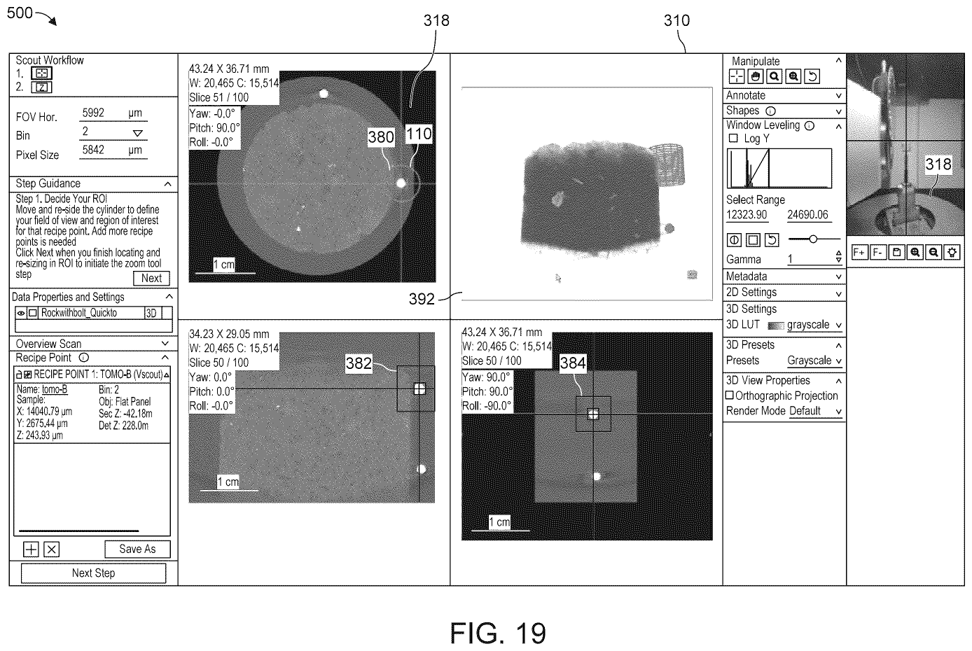

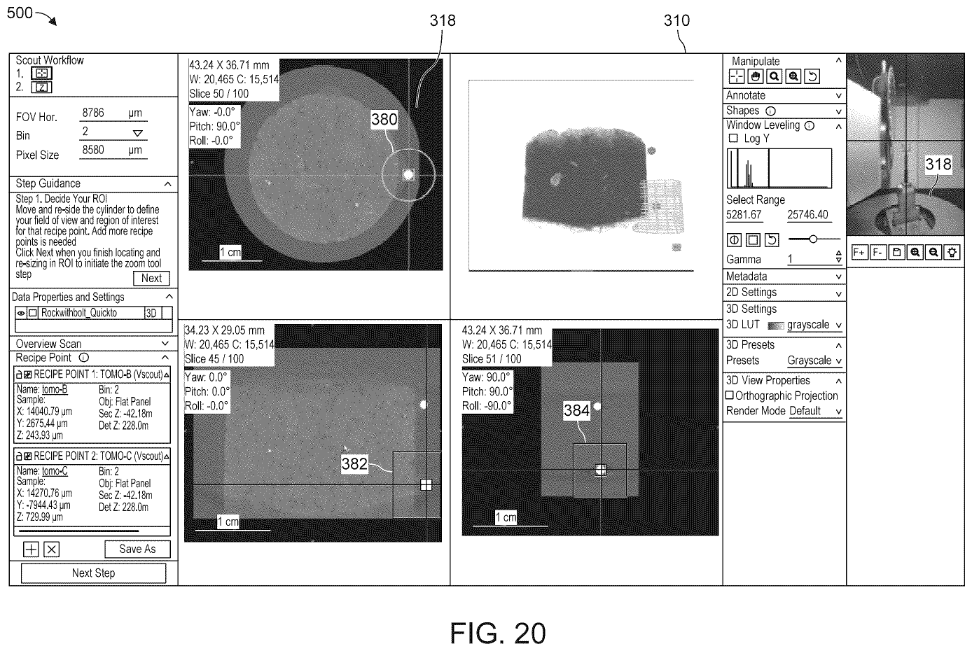

As shown in FIGS. 19 and 20, the system then creates one or more color-coded ROIs 380, 382, 384 in the 3D volume planes, each adjustable in location and in size which will determine where to acquire subsequent tomographies and at what field of view for the tomographies.

These ROIs 380, 382, 384 are labeled as ‘Volume Scout’ or ‘VS’ tomographies to distinguish themselves from any 2D projection scout tomographies.

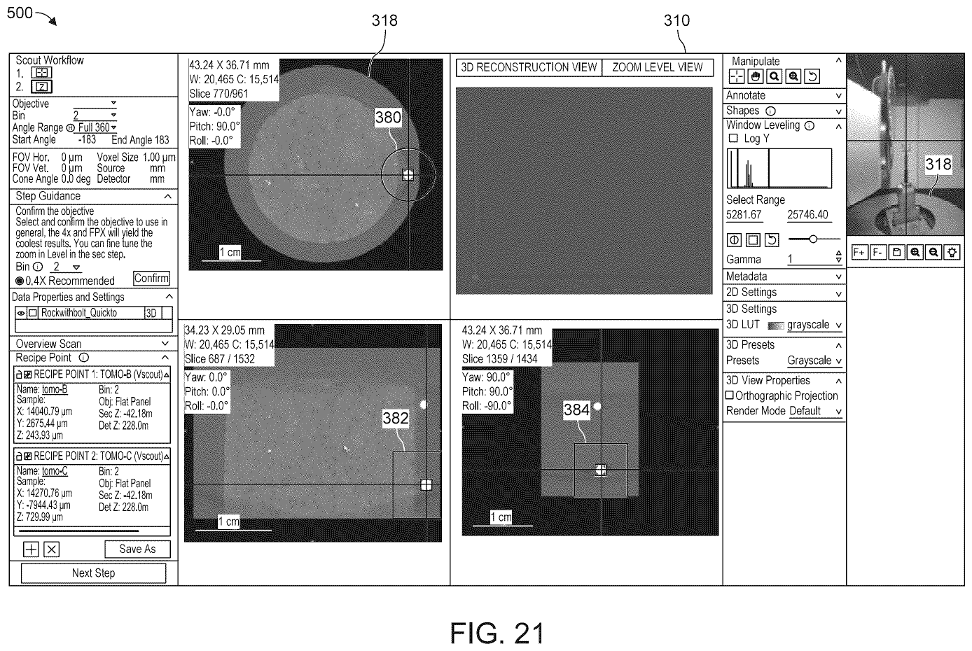

As shown in FIG. 21, for each VS tomography, the best objective to use can be determined based on the size of the FOV and the sample geometry. In addition, the ROI is then applied by the computer subsystem 224 to the precision 3-axis stage 150 that translates and positions the sample along the x, y, and z axes so that sample is positioned to the selected ROI.

While this invention has been particularly shown and described with references to preferred embodiments thereof, it will be understood by those skilled in the art that various changes in form and details may be made therein without departing from the scope of the invention encompassed by the appended claims.

1. A user interface rendered on a display of an X-ray microscopy system including a computer that processes projection data from the X-ray-microscopy system, the user interface:
displaying 2D projection images of a sample taken at two different rotational angles that are defined with respect to a rotational axis that is perpendicular or declined to an X-ray beam generated by an X-ray source subsystem and detected by a detector subsystem; and
displaying a region of interest (ROI) tool that is moved by user using user interface devices around the images to select at least one ROI and/or locate a center of the rotational axis of a sample table of the X-ray microscopy system.

2. The user interface as claimed in claim 1, wherein the location and size of a tomography of the sample can be defined without having to physically reconfigure the X-ray microscopy system to change the tomography system setup and after definition, the location and size is then applied to a 3-axis stage that translates and positions the sample along the x, y, and z axes so that sample is positioned according to the location and size.

3. The user interface as claimed in claim 1, wherein moving the ROI by user using the user interface devices in the 2D projection images specifies the unique X, Y, Z location of the center of the tomography.

4. The user interface as claimed in claim 1, wherein using the selected ROI location and size to determine a best geometrical magnification based on the size of the sample from a collision model.

5. The user interface as claimed in claim 1, wherein placement and size of the ROI is used to determine optical magnification and geometric magnification.

6. The user interface as claimed in claim 1, wherein the center of the rotational axis is located in all 3 dimensions (X, Y, Z).

7. An X-ray microscopy system, comprising:
an X-ray source subsystem of generating X-rays;
an object stage subsystem for holding a sample in the X-rays, wherein the object stage has a rotation axis and is movable in x, y, z directions;
a detector subsystem for detecting the X-rays after interaction with the sample; and
a computer for receiving projections from the detector subsystem and generating a user interface according to claim 1.

8. A user interface rendered on a display of an X-ray microscopy system including a computer that processes projection data of a sample from the microscopy system to reconstruct a tomography, the user interface:
enabling the acquisition of the tomography of sample;
enabling creating, moving and sizing of one or more regions of interest for multiple tomographies with a ROI tool; and
displaying the tomography along with the ROI tool in 3D volume planes to locate the center of the tomography, wherein the ROI of the sample is moved to the rotational axis that is perpendicular or declined to a beam generated by an X-ray source subsystem and detected by a detector subsystem.

9. The user interface as claimed in claim 8, wherein the ROI tool is sizable to reflect a desired pixel size in the tomography.

10. The user interface as claimed in claim 8, further comprising using the selected ROI location and size to determine an optical magnification.

11. The user interface as claimed in claim 8, further comprising using the selected ROI location and size to determine a best geometrical magnification based on the size of the sample from a collision model.

12. The user interface as claimed in claim 8, enables the user to confirm that the sample is in the correct location and enables the user to modify the location.

13. An X-ray microscopy system, comprising:
an X-ray source subsystem of generating X-rays;
an object stage subsystem for holding a sample in the X-rays, wherein the object stage has a rotation axis and is movable in x, y, z directions;
a detector subsystem for detecting the X-rays after interaction with the sample; and
a computer for receiving projections from the detector subsystem and generating a user interface according to claim 8.
